(19) United States
(12) Patent Application Publication
(10) Pub. No.: US 2022/0024009 A1
(43) Pub. Date: Jan. 27, 2022

(54) SYSTEM AND METHOD FOR LUG NUT CAP COVER REMOVAL TOOL

(71) Applicant: William C. Summers, St. George, SC (US)

(72) Inventor: William C. Summers, St. George, SC (US)

(21) Appl. No.: 17/383,427

(22) Filed: Jul. 22, 2021

Related U.S. Application Data
(60) Provisional application No. 63/055,368, filed on Jul. 23, 2020.

(51) Int. Cl. B25B 27/14

(52) U.S. Cl. CPC B25B 27/14; B60B 7/068

(57) ABSTRACT

A system and method for a lug nut cap cover removal tool that allows the user to quickly remove one or more lug nut caps in quick succession, the lug nut cap cover removal tool connected to a drill whereby when placed inside of a socket, the socket and removal tool spin in unison to remove the lug nut caps.

### CROSS REFERENCE TO RELATED APPLICATIONS

This application is a non-provisional application that claims priority to provisional application 63055368 filed on Jul. 23, 2020.

### FIELD OF DISCLOSURE

The overall field of this invention is directed to a tool, more particularly to lug nut cap cover removing device for quickly removing a plurality of lug nut cap covers

### BACKGROUND

Lug nut covers and bolt caps have been used for aesthetic purposes to improve the appearance of the wheels on a vehicle such as a tractor or truck. The lug nut covers are placed over the lug nuts on the tire's rim. Some lug nut covers are part of the lug nut and must be removed by cutting them off with metal cutters which damages the cover and the lug nut. Some lug nut covers must be removed to reach the lug nuts, which then must be removed in turn to take off the tire which is a time consuming process. These types of devices require the user to remove the lug nut covers by hand which can take up to twenty seconds for each lug nut cover to take off and on. Also, these devices do not accommodate for different sizes of lug nut covers. Thus exists a need for a system and method to quickly remove lug nut cap covers efficiently and effortlessly.

### SUMMARY

The embodiments of the present invention are directed to a system for removing lug nut cover caps comprising a removal tool, and a socket, whereby the a removal tool is positionable in the shaft at a first end, the removal tool configured to connect to a drill whereby when the removal tool is rotating the socket removes a lug nut cover positioned at a second end of the socket, whereby the removal tool has a dome shaped upper end with a hollow planar base adapted to abut against the shaft, whereby the dome shaped upper end has a plurality of flat side surfaces with adjacent side surfaces separated by a slot, whereby the flat side surfaces have five sides, whereby the flat side surfaces has a first and second side inclined upward to one another, a third side and fourth side extending down from the first side and the second side, the third side and the fourth side connected by a fifth side whereby the fifth side has a convex surface extending upward, whereby the hollow planar base has a perimeter larger than the dome shaped upper end, whereby the hollow planar base has a plurality of second side flat surfaces separated by second slots, whereby the second side flat surfaces have an upside down u-shape, whereby the removal tool has a shaft extending down from the domed shaped upper end and extending past the hollow planar base, whereby the shaft has a top portion of greater circumference than a bottom portion, whereby the shaft has a threaded portion, whereby the socket has a hexagonal sidewall that extends into openings at the first end and the second end, whereby the removal tool is injection molded plastic with a chrome plating, whereby the removal tool has a latch mechanism to be received in a hole on the socket to secure removal tool in place in relation to the socket

### BRIEF DESCRIPTION OF DRAWINGS

The present invention will be described by way of exemplary embodiments, but not limitations, illustrated in the accompanying drawings in which like references denote similar elements, and in which:

FIG. 1 is an illustration showing a perspective side view of the first embodiment and a second embodiment of lug nut cap cover removal tool.

FIG. 2 is an illustration showing a perspective side view of a first embodiment of lug nut cap cover removal tool.

FIG. 3 is an illustration showing another perspective side view of the first embodiment of lug nut cap cover removal tool.

FIG. 4 is an illustration showing a perspective view of the second embodiment of lug nut cap cover removal tool.

FIG. 5 is an illustration showing a perspective view of the second embodiment of lug nut cap cover removal tool along with a lug nut cover socket.

FIG. 6 is an illustration showing a perspective view of the second embodiment of lug nut cap cover removal tool along with a drill and lug nut cover socket.

### DETAILED DESCRIPTION

In the Summary above and in this Detailed Description, and the claims below, and the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” is used herein to mean “serving as an example, instance, or illustration.” Any aspect described in this document as “exemplary” is not necessarily to be construed as preferred or advantageous over other aspects.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any item, so a “set of items” may indicate the presence of only one item, or may indicate more items. Thus, the term “set” may be equivalent to “one or more” as used herein.

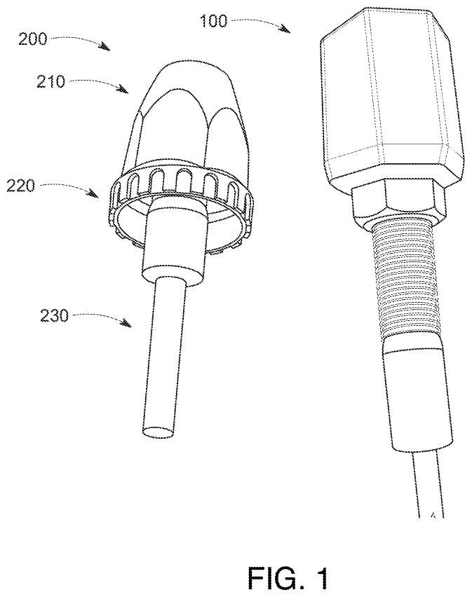

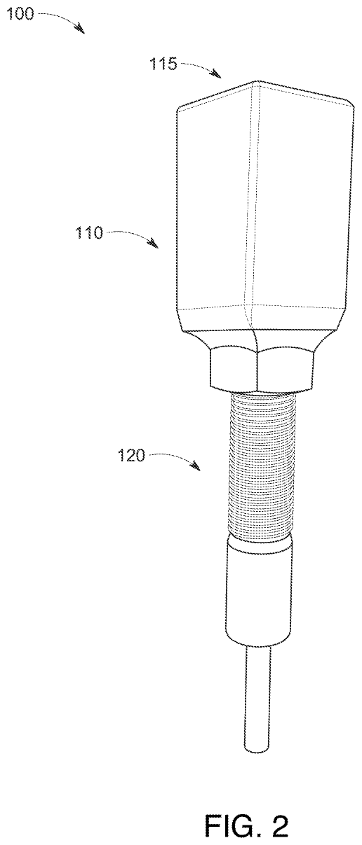

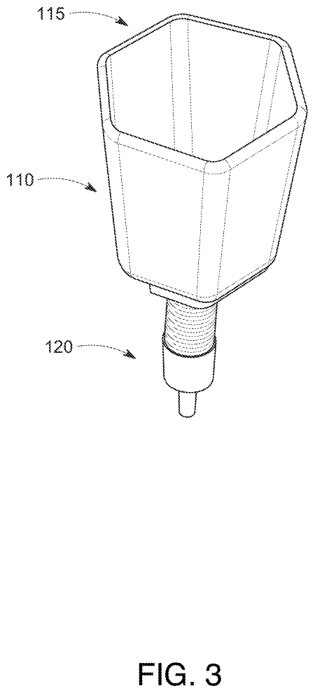

The present disclosure recognizes the unsolved need for a lug nut cap cover removal tool that allows the user to quickly remove one or more lug nut caps in quick succession. With reference now to FIGS. 1-3, one embodiment of lug nut cap cover removal tool 100, according to the present invention is generally designated, for use with lug nuts covers of a vehicle or other entity. Lug nut cap cover removal tool 100 may be made of an injected molded plastic that is platable and then chrome-plated. Lug nut cap cover removal tool 100 may also be made of other materials such as brass, copper, stainless steel, and aluminum, or any other suitable material all of which may be chrome-plated.

Lug nut cap cover removal tool 100 includes a socket portion 110 having a hexagonal wall. The hexagonal wall may have a series of sidewalls extending upward into a hexagonal opening 115 for mating with a lug nut. The hexagonal wall of socket portion 110 has a slightly larger perimeter than that of a lug nut cover such that it may be positioned over the lug nut cover whereby the lug nut cap cover may be rotated and removed or replaced by the rotation of lug nut cap cover removal tool 100. These figures are for illustrative purposes are non-limiting whereby socket portion 110 may be in many shapes and sizes including a thicker hexagonal wall to reduce the perimeter of hexagonal opening 115 to accommodate various lug nut covers.

The socket portion may be connected to a shaft 120 having a cylindrical top element of a circumference extending downward into a cylindrical middle element of a circumference smaller than the top element. The middle element may have a threaded portion on the exterior of the middle element extending downward into unthreaded portion. The middle element extends downward into a circular bottom element of a smaller circumference than the cylindrical middle element.

Lug nut cap cover removal tool 100 may be connected to any type of tool or device known by those of ordinary skill in the art such as a drill whereby shaft 120 may be connected to or otherwise received by a drill to unscrew the lug nut cap covers from a vehicle or other entity. The partially threaded configuration also allows shaft 120 to engage and mechanically lock with a drill or other tool. Correspondingly, a drill may have a threaded portion or be textured with a gnarled surface of one or more silicon threads with a metal core so as to mechanically lock shaft 230 to the drill.

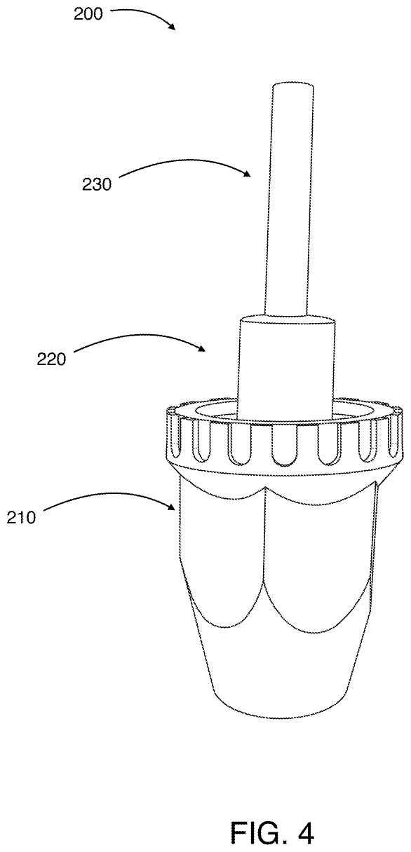

With reference now to FIGS. 1, and 4-6, another embodiment of lug nut cap cover removal tool 200, according to the present invention is generally designated, for use with lug nuts of a vehicle. Lug nut cap cover removal tool 200 may be made from injected molded plastic which is platable and then chrome-plated. Lug nut cap cover removal tool 200 may also be made of other materials such as brass, copper, stainless steel, and aluminum, or any other suitable material all of which may be chrome-plated.

Lug nut cap cover removal tool 200 has a dome-shaped upper end 210 and a planar base 220 which is adapted to abut against a shaft 230. Dome-shaped upper end 210 may have a plurality of flat side surfaces with adjacent side surfaces separated by slots. The flat side surfaces may have a first and second side inclined upward to one another, a third and fourth side extending down from the first and the second side, and a fifth side has a convex surface extending upward that connects the third and fourth side.

Planar base 220 may have a perimeter larger than dome-shaped upper end 210 and also have a plurality of flat side surfaces with adjacent side surfaces being separated by slots. The planar base flat side surfaces may be in the shape of U-shaped recesses pointing upwards.

Shaft 230 may have a cylindrical top element of a circumference extending downward into a cylindrical bottom element of a circumference smaller than the top element.

Lug nut cap cover removal tool 200 may be connected to any type of tool or device known by those of ordinary skill in the art such as a drill 300 whereby shaft 230 may be connected to or otherwise received by drill 300 to unscrew the lug nut cap covers from a vehicle or other entity. The partially threaded configuration also allows shaft 230 to engage and mechanically lock with drill 300 or another tool. Correspondingly, drill 300 may have a threaded portion or be textured with a gnarled surface of one or more silicon threads with a metal core to mechanically lock shaft 230 to drill 300.

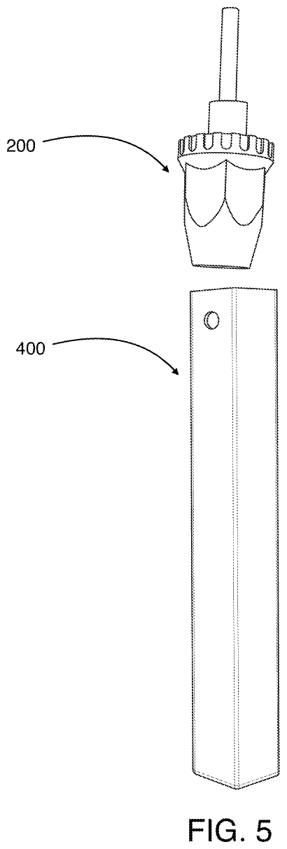

Lug nut cap cover removal tool 200 may be connected to any commonly used lug nut cover socket 400 as shown in FIG. 5. Lug nut cover socket 400 may be elongated in shape and have a hexagonal wall. The hexagonal wall may have a series of sidewalls extending into a first and second end opening 410. Lug nut cap cover removal tool 200 may be positioned inside first or second end opening 410. Similarly lug nut cap cover removal tool 100 may also be inserted into lug nut cover socket 400.

The outer perimeter of planar base 220 or another part of lug nut cap cover removal tool 200 may either be equal to or slightly smaller than an inner perimeter of lug nut cover socket 400 such that planar base 220 does not move relative to lug nut cover socket 400 unless an external force is applied to planar base 220 to overcome the friction between planar base 220 and lug nut cover socket 400. This connection allows lug nut cover socket 400 to rotate in unison with lug nut cap cover removal tool 200 when turned by drill 300.

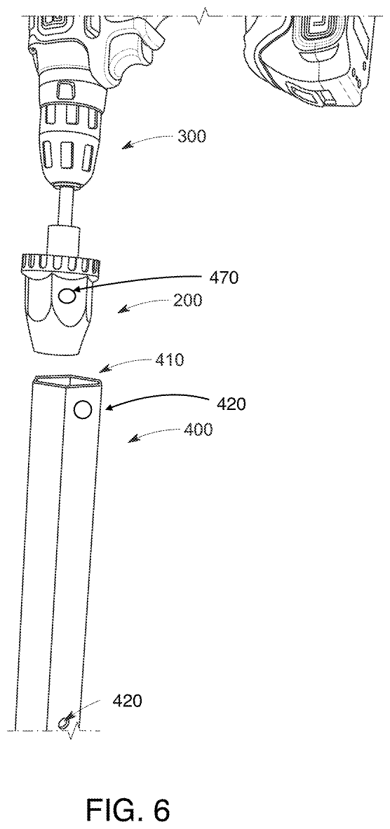

In some non-limiting embodiments, lug nut cap cover removal tool 200 may have a latch mechanism such as latch mechanism 260, in FIG. 6, to secure lug nut cover socket 400 to lug nut cover socket 400 whereby latch mechanism 260 may be positioned in a created cavity on removal tool 200. Latch mechanism 260 may be comprised of a push button mechanism operable in relation to a hole such as hole 420 formed through lug nut cover socket 400 near an end opening 410 whereby push button mechanism is used to secure lug nut cap cover removal tool 200 within lug nut cover socket 400 The push button mechanism is provided with a button, fixed to a spring clip, or any variation thereof. The clip is preferably formed of a resilient metal strip bent over on itself and having a distal side which, when compressed within the inner component, exerts an outward force on the button. This outward force maintains the push button mechanism in an engaged position with the button extending through a hole on lug nut cap cover removal tool 200.

Depressing the button of the push button mechanism releases latch mechanism 260 onto a disengaged position whereby lug nut cap cover removal tool 200 may freely move relative to lug nut cover socket 400. Once the depressing force is terminated, the expansive force of the push button mechanism causes the button to protrude out of the hole on lug nut cap cover removal tool 200 with which it comes into alignment with the corresponding hole 420 formed through lug nut cover socket 400.

In further embodiments lug nut cap cover removal tool 100 may be positioned into lug nut cover socket 400 to reduce the size of first and second opening 410 to accommodate different sizes of lug nut covers. lug nut cap cover removal tool 100 may also have a similar latch mechanism 160 having a push button mechanism whereby lug nut cap cover removal tool 100 may be inserted into lug nut cover socket 400 and secured when the button of the push button mechanism protrudes out of the hole lug on nut cap cover removal tool 100 when it comes into alignment with the corresponding hole 420 formed through lug nut cover socket 400.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A system for removing lug nut cover caps comprising:
a removal tool; and
a socket, wherein the removal tool is positionable in the socket at a first end, the removal tool configured to connect to a drill wherein when the removal tool is rotating the socket removes a lug nut cover positioned at a second end of the socket.

2. The system of claim 1: wherein the removal tool has a dome-shaped upper end with a hollow planar base adapted to abut against the socket.

3. The system of claim 2: wherein the dome-shaped upper end has a plurality of flat side surfaces with adjacent side surfaces separated by a slot.

4. The system of claim 3: wherein the flat side surfaces have five sides.

5. The system of claim 4: wherein the flat side surfaces has a first and second side inclined upward to one another, a third side and fourth side extending down from the first side and the second side, the third side and the fourth side connected by a fifth side wherein the fifth side has a convex surface extending upward.

6. The system of claim 5: wherein the hollow planar base has a perimeter larger than the dome-shaped upper end.

7. The system of claim 6: wherein the hollow planar base has a plurality of second side flat surfaces separated by second slots.

8. The system of claim 7: wherein the second side flat surfaces have an upside-down u-shape.

9. The system of claim 8: wherein the removal tool has a shaft extending down from the domed-shaped upper end and extending past the hollow planar base.

10. The system of claim 9: wherein the shaft has a top portion of greater circumference than a bottom portion.

11. The system of claim 10: wherein the shaft has a threaded portion.

12. The system of claim 11: wherein the socket has a hexagonal sidewall that extends into openings at the first end and the second end.

13. The system of claim 12: wherein the removal tool is injection molded plastic with a chrome plating.

14. The system of claim 13: wherein the removal tool has a latch mechanism to be received in a hole on the socket to secure the removal tool in place in relation to the socket.

15. A system for removing lug nut cover caps comprising:
a removal tool; and
a drill connected to the removal tool;
a socket, wherein the removal tool is positionable in the socket at a first end, wherein when rotated the socket removes at lug nut cover at an end of the socket.

16. The system of claim 15: wherein the removal tool has a dome-shaped upper end with a hollow planar base adapted to abut against the socket, the dome-shaped upper end having a plurality of flat side surfaces with adjacent side surfaces separated by a slot, wherein the hollow planar base has a perimeter larger than the dome-shaped upper end, wherein the removal tool has a shaft extending down from the domed shaped upper end and extending past the hollow planar base, wherein the shaft has a smaller circumference than the hollow planar base.

17. The system of claim 15: wherein the socket has a hexagonal sidewall that extends into openings at the first end and a second end.

18. The system of claim 15: wherein the removal tool is injection molded plastic with a chrome plating.

19. The system of claim 15: wherein the removal tool has a latch mechanism to be received in a hole on the socket to secure the removal tool in place in relation to the socket.

20. The system of claim 19: wherein the latch mechanism is a push-button mechanism.
